(19) United States
(12) Patent Application Publication
(10) Pub. No.: US 2015/0350580 A1
(43) Pub. Date: Dec. 3, 2015

(54) SOLID-STATE IMAGING DEVICE AND IMAGING METHOD

(71) Applicant: Kabushiki Kaisha Toshiba, Minato-ku (JP)

(72) Inventor: Maki SATO, Yamato (JP)

(73) Assignee: Kabushiki Kaisha Toshiba, Minato-ku (JP)

(21) Appl. No.: 14/633,816

(22) Filed: Feb. 27, 2015

(30) Foreign Application Priority Data
May 30, 2014 (JP) 2014-112526

(51) Int. Cl. H04N 5/374; H04N 5/378

(52) U.S. Cl. CPC H04N 5/374; H04N 5/378

(57) ABSTRACT

According to one embodiment, a solid-state imaging device includes selecting circuits, read switching circuits, and a switching control circuit. The selecting circuits are configured to select some of weighting circuits to be used for weighting, in association with pixel signals read through plural ones of vertical signal lines. The read switching circuits are configured to switch read directions of pixel signals from the vertical signal lines. The switching control circuit is configured to output a control signal for switching selection of the weighting circuits to the circuit selection circuits, in response to switching of the read directions.

### CROSS-REFERENCE TO RELATED APPLICATIONS

This application is based upon and claims the benefit of priority from Japanese Patent Application No. 2014-112526, filed on May 30, 2014; the entire contents of which are incorporated herein by reference.

### FIELD

An embodiment described herein relates generally to a solid-state imaging device and imaging method.

### BACKGROUND

Conventionally, as one of the processes performed by a CMOS image sensor, there is known so-called weighting addition. According to this weighting addition, the CMOS image sensor adds up, at a certain constant ratio, the signal levels of identical color pixels present in a juxtaposed state in the horizontal direction within a pixel array.

Further, in the case of a CMOS image sensor including AD converters arranged on both of the upper and lower sides of a pixel array in the vertical direction, there is known a technique of reading pixel signals while constantly switching the read directions of vertical signal lines. The green pixels includes green pixels (Gr pixels) adjacent to red (R) pixels in the horizontal direction and green pixels (Gb pixels) adjacent to blue (B) pixels in the horizontal direction. When signals from the Gr pixels and signals from the Gb pixels are respectively input into different AD converters, an output difference may be caused between the Gr pixels and the Gb pixels due to a disagreement in reference voltage between the AD converters. By switching the read directions of vertical signal lines at every horizontal read period (one H), signals from the Gr pixels and signals from the Gr pixels can be input into AD converters arranged on the same side. Consequently, the output difference between the Gr pixels and the Gb pixels after AD conversion can be reduced, and the solid-state imaging device can thereby obtain a high quality image.

If such a read method is combined with the weighting addition described above, pixel signals input into weighting circuits for performing weighting will be switched at every one H. In this case, the weighting addition can be performed at a desired ratio in a certain read period, but this desired weighting addition cannot be maintained in the next read period, because of a change in the pattern of signals input into the weighting circuits.

### BRIEF DESCRIPTION OF THE DRAWINGS

FIG. 1 is a block diagram showing a schematic configuration of a solid-state imaging device according to an embodiment;

FIG. 2 is a block diagram showing a schematic configuration of a digital camera equipped with the solid-state imaging device shown in FIG. 1;

FIG. 3 is a view showing a schematic configuration of an optical system provided in the digital camera shown in FIG. 2;

FIG. 4 is a view for explaining switching of the read directions of vertical signal lines shown in FIG. 1;

FIG. 5 is a view for explaining an operation of read switching parts shown in FIG. 1 and weighting addition at a ratio of 2:1 performed by a weighting addition circuit shown in FIG. 1;

FIG. 6 is a view for explaining an operation of the read switching parts shown in FIG. 1 and weighting addition at a ratio of 1:2:1 performed by the weighting addition circuit shown in FIG. 1;

FIG. 7 is a view showing a first operation example of the solid-state imaging device shown in FIG. 1;

FIG. 8 is a view showing an internal configuration of selection switches shown in FIG. 7;

FIG. 9 is a view showing a second operation example of the solid-state imaging device shown in FIG. 1;

FIG. 10 is a view showing a third operation example of the solid-state imaging device shown in FIG. 1;

FIG. 11 is a view showing a fourth operation example of the solid-state imaging device shown in FIG. 1;

FIG. 12 is a view showing a fifth operation example of the solid-state imaging device shown in FIG. 1; and

FIG. 13 is a view showing a sixth operation example of the solid-state imaging device shown in FIG. 1.

### DETAILED DESCRIPTION

In general, according to one embodiment, a solid-state imaging device includes a pixel array, a weighting addition circuit, selection circuits, read switching circuits, and a switching control circuit. The weighting addition circuit includes weighting circuits. The weighting circuits are configured to perform weighting to pixel signals read from the pixel array through vertical signal lines. The weighting addition circuit is configured to add up the pixel signals subjected to the weighting. The selecting circuits are configured to select some of the weighting circuits to be used for the weighting, in association with pixel signals read through plural ones of the vertical signal lines. The read switching circuits are configured to switch read directions of pixel signals from the vertical signal lines. The switching control circuit is configured to output a control signal for switching selection of the weighting circuits to the selecting circuits, in response to switching of the read directions.

An exemplary embodiment of a solid-state imaging device and imaging method will be explained below in detail with reference to the accompanying drawings. The present invention is not limited to the following embodiment.

### Embodiment

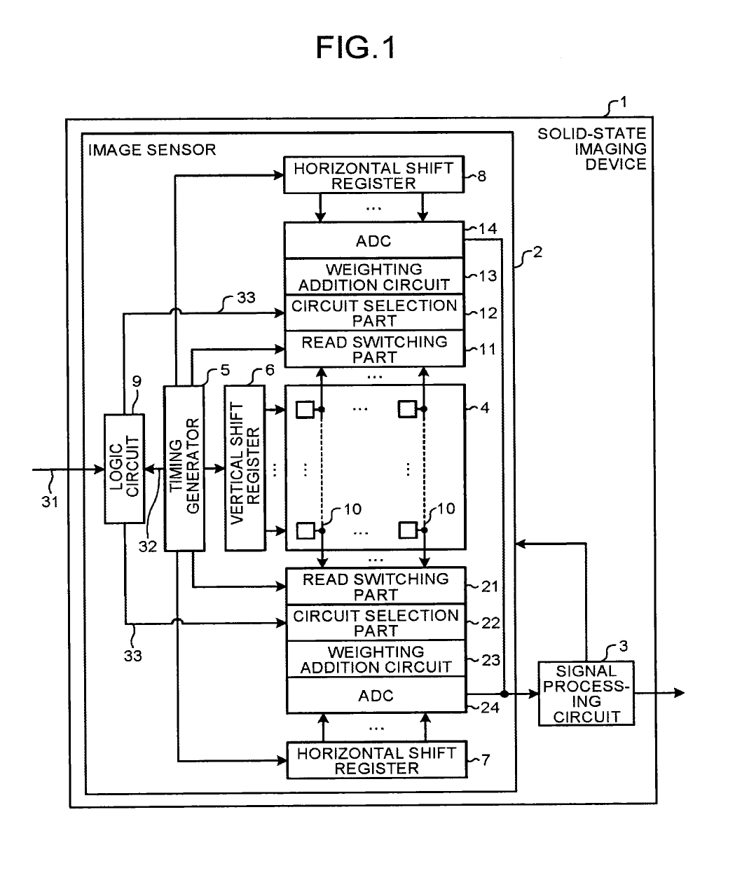

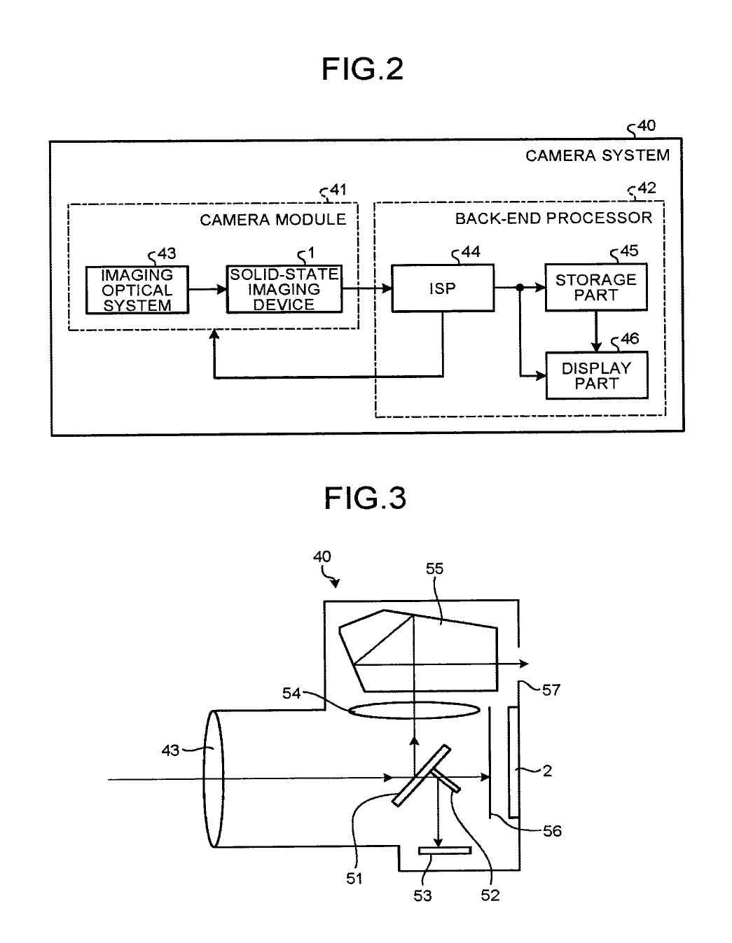

FIG. 1 is a block diagram showing a schematic configuration of a solid-state imaging device according to an embodiment. FIG. 2 is a block diagram showing a schematic configuration of a camera system equipped with the solid-state imaging device shown in FIG. 1. FIG. 3 is a view showing a schematic configuration of an optical system provided in the camera system shown in FIG. 2.

The camera system 40 is an electronic apparatus including a camera module 41, such as a digital camera. The digital camera may be either one of a digital still camera and a digital video camera. The camera system 40 may be an electronic apparatus other than a digital camera, such as a mobile terminal apparatus with a camera.

The camera system 40 includes the camera module 41 and a back-end processor 42. The camera module 41 includes an imaging optical system 43 and a solid-state imaging device 1. The back-end processor 42 includes an image signal processor (ISP) 44, a storage part 45, and a display part 46.

The imaging optical system 43 takes in light from an object and forms an object image. The solid-state imaging device 1 images the object image. The ISP 44 performs a signal process to the image signal obtained by the imaging in the solid-state imaging device 1. The storage part 45 stores the image subjected to the signal process by the ISP 44. The storage part 45 outputs an image signal to the display part 46, in response to user operations or the like.

When light is incident from the object onto the imaging optical system 43 of the camera system 40, it advances, through a main mirror 51, a sub mirror 52, and a mechanical shutter 56, onto an image sensor 2. The camera system 40 images an object image at the image sensor 2.

Light reflected by the sub mirror 52 advances onto an automatic focus (AF) sensor 53. The camera system 40 performs focus adjustment by use of detection results obtained by the AF sensor 53. Light reflected by the main mirror 51 advances, through a lens 54 and a prism 55, onto a finder 57.

The solid-state imaging device 1 includes the image sensor 2 and a signal processing circuit 3. The image sensor 2 serving as an imaging element images an object image. The image sensor 2 is a CMOS image sensor, for example. The image sensor 2 includes a pixel array 4, a timing generator 5, a vertical shift register 6, horizontal shift registers 7 and 8, and a logic circuit 9 serving as a switching control circuit. The image sensor 2 includes read switching parts 11 and 21 serving as read switching circuits, circuit selection parts 12 and 22 serving as selecting circuits, weighting addition circuits 13 and 23, and analog/digital converters (ADCs) 14 and 24.

The pixel array 4 is arranged within an imaging area of the image sensor 2. The pixel array 4 is composed of pixels arranged in an array format in horizontal directions and vertical directions. Each of the pixels includes a photo diode serving as a photoelectric conversion element. The photoelectric conversion element generates a signal charge corresponding to incident light quantity. Each of the pixels accumulates the signal charge corresponding to incident light quantity. Each of vertical signal lines 10 outputs pixel signals from corresponding pixels arrayed in a vertical direction of the pixel array 4.

Each of the pixels is provided with a color filter (not shown) on the incident side, in accordance with the color array. Each of the pixels detects colored light transmitted through the color filter. The pixels of different colors, which are assigned to detect respective color components of light, are arranged to form a Bayer array.

The timing generator 5 generates clocks for controlling various kinds of timing. The timing generator 5 generates a vertical scan clock corresponding to a vertical synchronous signal, and outputs it to the vertical shift register 6. The timing generator 5 generates a horizontal scan clock corresponding to a horizontal synchronous signal, and outputs it to each of the horizontal shift registers 7 and 8.

The vertical shift register 6 selects a row of pixels to read signals therefrom, in response to the vertical scan clock from the timing generator 5. The vertical shift register 6 outputs a read signal to each of the pixels on the selected row. Upon reception of an input of the read signal from the vertical shift register 6, each of the pixels outputs a signal charge accumulated therein to the corresponding one of the vertical signal lines 10. The horizontal shift register 7 supplies the ADCs 24 with the horizontal scan clock given from the timing generator 5. The horizontal shift register 8 supplies the ADCs 14 with the horizontal scan clock given from the timing generator 5.

The timing generator 5 generates a switching instruction for instructing switching of the read directions of the vertical signal lines 10 at every horizontal read period (one H), and supplies it to each of the read switching parts 11 and 21. Here, one H is defined by a period of outputting pixel signals of the pixels on one row from the image sensor 2 as digital signals. The timing generator 5 generates a switching pulse signal 32 indicating the timing of switching the read directions of the vertical signal lines 10, and outputs it to the logic circuit 9.

The logic circuit 9 is a switching control part for generating a switching control signal 33, in response to a switching pulse signal 32 from the timing generator 5 and a mode setting signal 31. The switching control signal 33 is a control signal for controlling switching of selection of first weighting circuits in the circuit selection parts 12 and switching of selection of second weighting circuits in the circuit selection parts 22. The logic circuit 9 outputs the switching control signal 33 thus generated to each of the circuit selection parts 12 and 22. The camera module 41 can switch photographing modes, in response to a user operation, for example. A mode setting signal 31 corresponding to a photographing mode is input into the solid-state imaging device 1.

The read switching parts 11 and 21 switch the read directions of the vertical signal lines 10 respectively in a first direction and a second direction. The first direction is upward in the vertical direction. The second direction is opposite to the first direction, and namely it is downward in the vertical direction.

The circuit selection parts 12 serving as first selecting circuits select some of the first weighting circuits to be used for weighting, in association with pixel signals read upward in the vertical direction, i.e., in the first direction, from plural ones of the vertical signal lines 10.

The weighting addition circuit 13 serving as a first weighting addition circuit includes the first weighting circuits for performing weighting to pixel signals. In the weighting addition circuit 13, the pixel signals read upward in the vertical direction from the plural ones of the vertical signal lines 10 are subjected to weighting and then added up each other. The weighting addition circuit 13 synthesizes the pixel signals subjected to the weighting and thereby generates a synthetic pixel signal. The weighting addition circuit 13 outputs synthetic pixel signals thus generated.

The ADCs 14 serving as first AD converters perform AD conversion to the synthetic pixel signals from the weighting addition circuit 13. The ADCs 14 convert each of the synthetic pixel signals, which is an analog type signal, to a digital type signal.

The circuit selection parts 22 serving as second selecting circuits select some of the second weighting circuits to be used for weighting, in association with pixel signals read downward in the vertical direction, i.e., in the second direction, from plural ones of the vertical signal lines 10.

The weighting addition circuit 23 serving as a second weighting addition circuit includes the second weighting circuits for performing weighting to pixel signals. In the weighting addition circuit 23, the pixel signals read downward in the vertical direction from the plural ones of the vertical signal lines 10 are subjected to weighting and then added up each other. The weighting addition circuit 23 synthesizes the pixel signals subjected to the weighting and thereby generates a synthetic pixel signal. The weighting addition circuit 23 outputs synthetic pixel signals thus generated.

The ADCs 24 serving as second AD converters perform AD conversion to the synthetic pixel signals from the weighting addition circuit 23. The ADCs 24 convert each of the synthetic pixel signals, which is an analog type signal, to a digital type signal. The image sensor 2 outputs signals from the ADCs 14 and 24 as an image signal.

The signal processing circuit 3 can perform various signal processes to the image signal from the image sensor 2. The solid-state imaging device 1 outputs the image signal subjected to a signal process by the signal processing circuit 3 to the outside of the chip. The solid-state imaging device 1 performs feedback control to the image sensor 2, based on data derived from a signal process by the signal processing circuit 3.

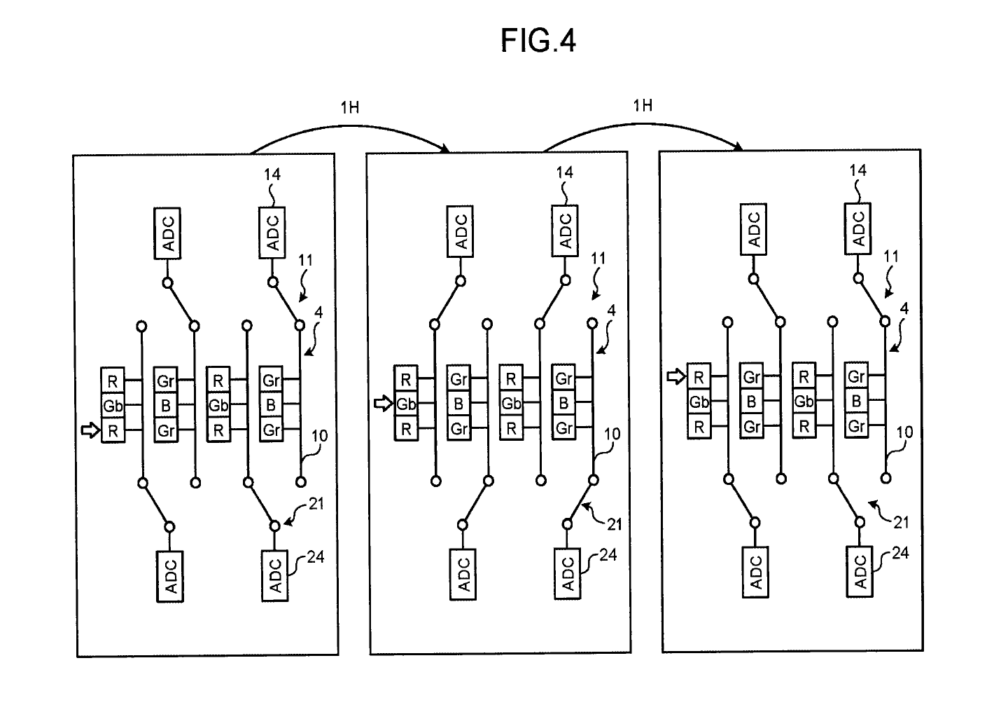

FIG. 4 is a view for explaining switching of the read directions of the vertical signal lines shown in FIG. 1. FIG. 4 shows transition of row selection and a read direction at every horizontal read period (one H). The read switching parts 11 and 21 switch connection and disconnection at every one H.

In the pixel array 4, red (R) pixels, blue (B) pixels, and green (G) pixels composed of Gr pixels and Gb pixels are arranged to form a Bayer array. The R pixels detect the signal level of R light. The B pixels detect the signal level of B light. The Gr pixels and the Gb pixels detect the signal level of G light. The Gr pixels are adjacent to the R pixels in the horizontal direction. The Gb pixels are adjacent to the B pixels in the horizontal direction.

The Bayer array is defined by use of a 2×2 pixel block as a unit. An R pixel and a B pixel are arranged at diagonal positions in this pixel block. A Gr pixel and a Gb pixel are arranged at the other diagonal positions in this pixel block.

In the first one H shown in FIG. 4, the vertical shift register 6 selects a row of R pixels and Gr pixels. In this one H, for example, the read switching parts 11 disconnect the ADCs 14 from the vertical signal lines 10 that output pixel signals from the Gb pixels and the R pixels, and connect the ADCs 14 to the vertical signal lines 10 that output pixel signals from the B pixels and the Gr pixels. Thus, the pixel signals from the Gr pixels are input into the ADCs 14.

Further, the read switching parts 21 connect the ADCs 24 to the vertical signal lines 10 that output pixel signals from the Gb pixels and the R pixels, and disconnect the ADCs 24 from the vertical signal lines 10 that output pixel signals from the B pixels and the Gr pixels. Thus, the pixel signals from the R pixels are input into the ADCs 24.

In the next one H, the vertical shift register 6 selects a row of Gb pixels and B pixels. In this one H, the read switching parts 11 connect the ADCs 14 to the vertical signal lines 10 that output pixel signals from the Gb pixels and the R pixels, and disconnect the ADCs 14 from the vertical signal lines 10 that output pixel signals from the B pixels and the Gr pixels. Thus, the pixel signals from the Gb pixels are input into the ADCs 14.

Further, the read switching parts 21 disconnect the ADCs 24 from the vertical signal lines 10 that output pixel signals from the Gb pixels and the R pixels, and connect the ADCs 24 to the vertical signal lines 10 that output pixel signals from the B pixels and the Gr pixels. Thus, the pixel signals from the B pixels are input into the ADCs 24. In the further next one H, the vertical shift register 6 selects a row of R pixels and Gr pixels, and the read switching parts 11 and 21 further perform switching, to set the same state as in the first one H shown in FIG. 4.

In this way, the image sensor 2 switches the read directions of the vertical signal lines 10. Consequently, the pixel signals from the Gr pixels and the pixel signals from the Gb pixels are input constantly into the ADCs 14 on the upper side, and the pixel signals from the R pixels and the pixel signals from the B pixels are input constantly into the ADCs 24 on the lower side.

A disagreement in reference voltage (VREF) between the ADCs 14 and the ADCs 24 may occur. If the pixel signals from the Gr pixels and the pixel signals from the Gb pixels are input into the ADCs 14 and the ADCs 24 on the sides different from each other, the image sensor 2 causes an output difference between their pixel signals after AD conversion due to the disagreement. Due to such an output difference, there is a case where the solid-state imaging device 1 generates a lattice-like pattern, which is not present on the object, on the image.

However, the image sensor 2 is configured such that the pixel signals from the Gr pixels and the pixel signals from the Gb pixels are input constantly into the ADCs 14 on the same side, by which it reduces the output difference after AD conversion. Consequently, the solid-state imaging device 1 can suppress generation of the lattice-like pattern, and can thereby obtain a high quality image. In this respect, the image sensor 2 may be configured to input the pixel signals from the Gr pixels and the pixel signals from the Gb pixels into the ADCs 24 on the lower side.

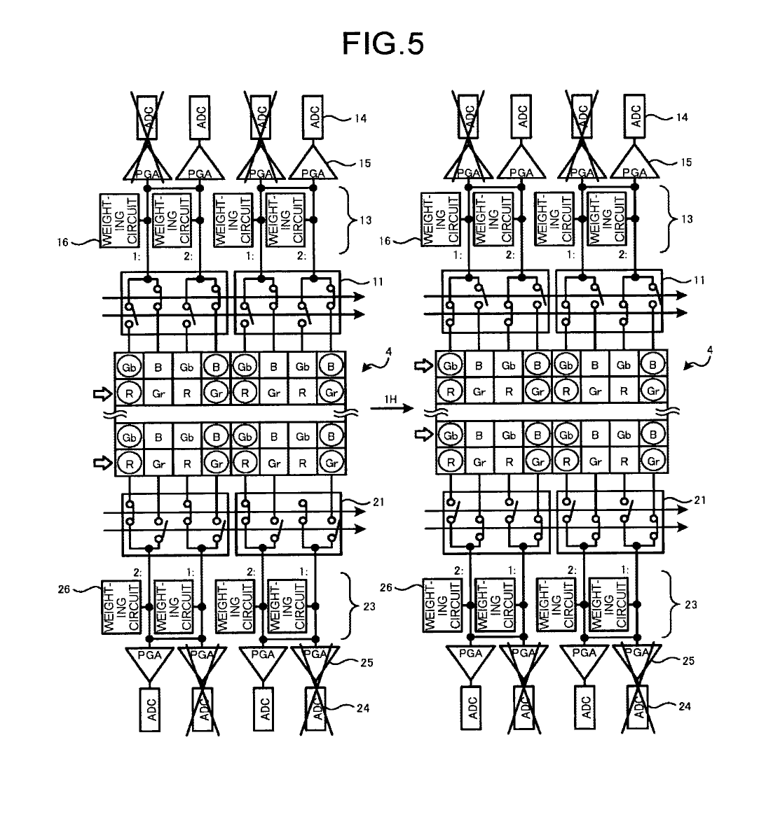

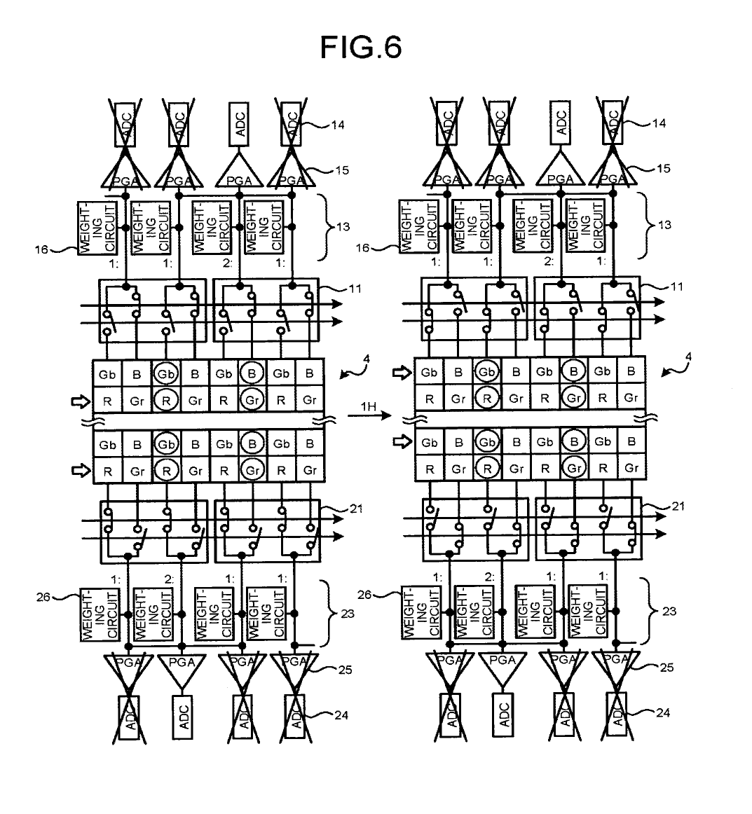

FIGS. 5 and 6 are views for explaining an operation of the read switching parts shown in FIG. 1 and weighting addition performed by the weighting addition circuit shown in FIG. 1. FIGS. 5 and 6 show a configuration according to this embodiment by omitting the circuit selection parts 12 and 22 and the logic circuit 9.

In the pixel array 4, pixels shown with a circle added thereto indicate that these pixels are given a larger weight by weighting addition as compared with other pixels, and that, in other words, these pixels are weighted centers in the weighting addition.

FIG. 5 is a view showing part of a configuration of the image sensor in detail. FIG. 5 shows a case where weighting addition is performed at a ratio of 2:1 and the read directions are switched at every one H. In the first one H shown in FIG. 5, the vertical shift register 6 selects a row of R pixels and Gr pixels. The read switching parts 11 connect the vertical signal lines 10 of the columns of B pixels and Gr pixels to the weighting addition circuit 13. The read switching parts 21 connect the vertical signal lines 10 of the columns of Gb pixels and R pixels to the weighting addition circuit 23.

Pixel signals read upward in the vertical direction from four vertical signal lines 10 are input into each of the read switching parts 11. Each of the read switching parts 11 switches the connection and disconnection of the four vertical signal lines 10, in response to a switching instruction from the timing generator 5. Each of the read switching parts 11 outputs pixel signals from two vertical signal lines 10, which are set in the connection state, of the four vertical signal lines 10.

In the weighting addition circuit 13, weighting circuits 16 are respectively connected to the inputs from the read switching parts 11. Programmable gain amplifier circuits (PGA) 15 are respectively connected to the outputs of the weighting circuits 16. Each of the PGAs 15 multiplies a synthetic pixel signal from the weighting addition circuit 13 by a gain. The ADCs 14 are respectively connected to the outputs of the PGAs 15.

Each of the synthetic pixel signals from the weighting addition circuit 13 is input into one of two column sets of a PGA 15 and an ADC 14, which is connected to the weighting addition circuit 13. The other column set of a PGA 15 and an ADC 14, into which the synthetic pixel signal is not input, is disconnected from the power supply.

Pixel signals read downward in the vertical direction from four vertical signal lines 10 are input into each of the read switching parts 21. Each of the read switching parts 21 has the same configuration as that of each read switching part 11.

In the weighting addition circuit 23, weighting circuits 26 are respectively connected to the inputs from the read switching parts 21. Programmable gain amplifier circuits (PGA) 25 are respectively connected to the outputs of the weighting circuits 26. Each of the PGAs 25 multiplies a synthetic pixel signal from the weighting addition circuit 23 by a gain. The ADCs 24 are respectively connected to the outputs of the PGAs 25.

Each of the synthetic pixel signals from the weighting addition circuit 23 is input into one of two column sets of a PGA 25 and an ADC 24, which is connected to the weighting addition circuit 23. The other column set of a PGA 25 and an ADC 24, into which the synthetic pixel signal is not input, is disconnected from the power supply. In this way, the ADCs 14 and 24 are disconnected from the power supply at every two columns, so that the solid-state imaging device 1 can reduce power consumption.

In the configuration shown in FIG. 5, the weighting addition circuit 13 is in a state where the routes of pixel signals from the Gr pixels not to be weighted centers are respectively connected to weighting circuits 16 for weighting of “1”. In the state, the routes of pixel signals from the Gr pixels to be weighted centers are respectively connected to weighting circuits 16 for weighting of “2”. Further, the weighting addition circuit 23 is in a state where the routes of pixel signals from the R pixels to be weighted centers are respectively connected to weighting circuits 26 for weighting of “2”. In the state, the routes of pixel signals from the R pixels not to be weighted centers are respectively connected to weighting circuits 26 for weighting of “1”. In this one H, the image sensor 2 can obtain synthetic pixel signals subjected to weighting at a desired ratio of 2:1.

In the next one H, the vertical shift register 6 selects a row of Gb pixels and B pixels. The read switching parts 11 connect the vertical signal lines 10 of the columns of Gb pixels and R pixels to the weighting addition circuit 13. The read switching parts 21 connect the vertical signal lines 10 of the columns of B pixels and Gr pixels to the weighting addition circuit 23.

In the configuration shown in FIG. 5, the weighting addition circuit 13 is in a state where the routes of pixel signals from the Gb pixels to be weighted centers are respectively connected to weighting circuits 16 for weighting of “1”. In the state, the routes of pixel signals from the Gb pixels not to be weighted centers are respectively connected to weighting circuits 16 for weighting of “2”. Further, the weighting addition circuit 23 is in a state where the routes of pixel signals from the B pixels not to be weighted centers are respectively connected to weighting circuits 26 for weighting of “2”. In the state, the routes of pixel signals from the B pixels to be weighted centers are respectively connected to weighting circuits 26 for weighting of “1”.

In this one H, weighting of “1” is applied to pixel signals that should be given weighting of “2”, and weighting of “2” is applied to pixel signals that should be given weighting of “1”. At this time, weighting is performed with weighted centers opposite to those of the desired weighting, and so the image sensor 2 cannot obtain pixel signals subjected to the desired weighting.

FIG. 6 shows a case where weighting addition is performed at a ratio of 1:2:1 and the read directions are switched at every one H. This case can be examined as in the case shown in FIG. 5, as follows. In the first one H shown in FIG. 6, the weighting addition circuit 13 is in a state where the routes of pixel signals from the Gr pixels to be weighted centers are respectively connected to weighting circuits 16 for weighting of “2”. In the state, the routes of pixel signals from the Gr pixels not to be weighted centers are respectively connected to weighting circuits 16 for weighting of “1”.

Further, the weighting addition circuit 23 is in a state where the routes of pixel signals from the R pixels to be weighted centers are respectively connected to weighting circuits 26 for weighting of “2”. In the state, the routes of pixel signals from the R pixels not to be weighted centers are respectively connected to weighting circuits 26 for weighting of “1”. In this one H, the image sensor 2 can obtain pixel signals subjected to weighting at a desired ratio of 1:2:1.

In the next one H, the weighting addition circuit 13 is in a state where the routes of pixel signals from the Gb pixels to be weighted centers are respectively connected to weighting circuits 16 for weighting of “1”. Further, as regards the routes of pixel signals from the Gr pixels not to be weighted centers, one half (one of two) of them are respectively connected to weighting circuits 16 for weighting of “1”, and the other half of them are respectively connected to weighting circuits 16 for weighting of “2”.

Further, the weighting addition circuit 23 is in a state where the routes of pixel signals from the B pixels to be weighted centers are respectively connected to weighting circuits 26 for weighting of “1”. Further, as regards the routes of pixel signals from the B pixels not to be weighted centers, one half (one of two) of them are respectively connected to weighting circuits 26 for weighting of “1”, and the other half of them are respectively connected to weighting circuits 26 for weighting of “2”. In this one H, the image sensor 2 cannot obtain pixel signals subjected to weighting at a desired ratio of 1:2:1.

In a case where the weighting addition circuits 13 and 23 are directly connected to the read switching parts 11 and 21, pixel signals input into the weighting circuits 16 and 26 are switched at every one H in the solid-state imaging device 1. The weighting addition circuits 13 and 23 can perform weighting addition at a desired ratio in a certain read period, but they come to perform a process different from the desired weighting addition in the next read period, because of a change in the pattern of pixel signals input into the weighting circuits 16 and 26. Accordingly, it becomes difficult to perform a desired signal process by the solid-state imaging device 1.

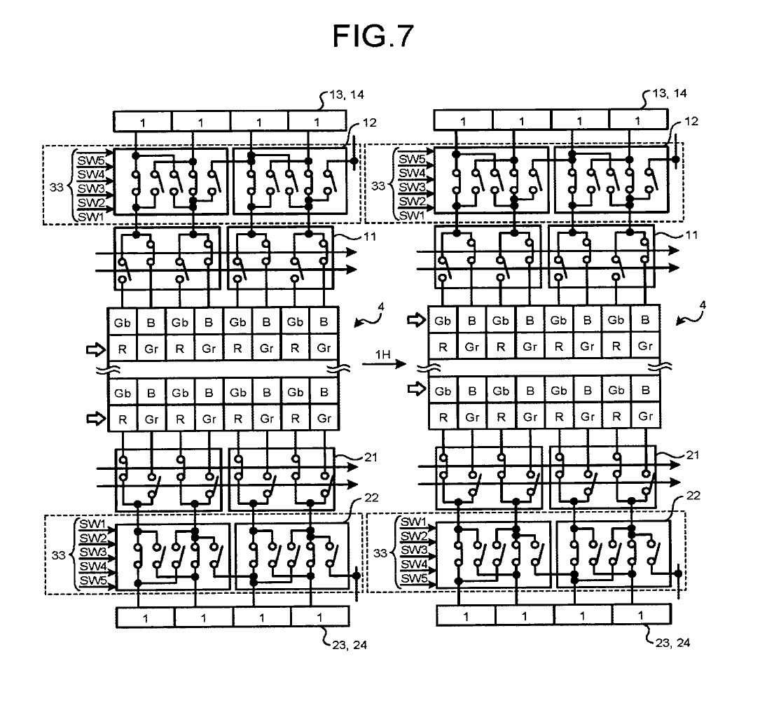

Next, with reference to FIGS. 7 to 13, an explanation will be given of the read direction switching and the weighting addition, by use of a configuration including the circuit selection parts 12 and 22 and the logic circuit 9. Here, it is assumed that the solid-state imaging device 1 can switch processes in the weighting addition circuits 13 and 23, for example, between a process performed without the weighting addition, a process performed with the 2-pixel weighting addition, and a process performed with the 3-pixel weighting addition. The 2-pixel weighting addition is weighting addition using two identical color pixels present in a juxtaposed state in the horizontal direction, such as weighting addition of 2:1. The 3-pixel weighting addition is weighting addition using three identical color pixels present in a juxtaposed state in the horizontal direction, such as weighting addition of 1:2:1.

Further, it is assumed that the solid-state imaging device 1 can change the presence/absence of switching of the read directions of the vertical signal lines 10, for example. The solid-state imaging device 1 performs the weighting addition switching and the presence/absence change of the read direction switching, in response to photographing mode switching, for example. The logic circuit 9 generates a switching control signal 33 for switching the control over the circuit selection parts 12 and 22, in response to a mode setting signal 31 for instructing the setting of a photographing mode.

The logic circuit 9 includes registers that hold switching control information about respective photographing modes. The switching control information contains the presence/absence of the read direction switching and the weighting addition contents in the weighting addition circuits 13 and 23. The logic circuit 9 generates a switching control signal 33 for controlling the circuit selection parts 12 and 22, in accordance with the switching control information read in response to the mode setting signal 31.

Pixel signals from two vertical signal lines 10 connected by each of the read switching parts 11 are input into corresponding one of the circuit selection parts 12. In the weighting addition circuit 13, inputs from the circuit selection parts 12 are respectively connected to weighting circuits 16 serving as respective first weighting circuits. Pixel signals from two vertical signal lines 10 connected by each of the read switching parts 21 are input into corresponding one of the circuit selection parts 22. In the weighting addition circuit 23, inputs from the circuit selection parts 22 are respectively connected to weighting circuits 26 serving as respective first weighting circuits. Each of the circuit selection parts 12 and 22 includes five switches (SW1 to SW5) provided inside and switchable between connection (ON) and disconnection (OFF).

FIG. 7 is a view showing a first operation example of the solid-state imaging device shown in FIG. 1. The first operation example is an operation of the solid-state imaging device 1 performed without the weighting addition and without the read direction switching. A mode setting signal 31 for an operation performed without the weighting addition and without the read direction switching is input into the solid-state imaging device 1. The logic circuit 9 reads switching control information corresponding to the contents of this mode setting signal 31 from a register.

The switching control information read in the first operation example has such contents that use each of the circuit selection parts 12 and the circuit selection parts 22 to set the SW1 to SW5 respectively in ON, OFF, OFF, ON, and OFF, regardless of the horizontal read period. The logic circuit 9 outputs a switching control signal 33 containing the switching control information thus read. The switching control signal 33 is input into each of the circuit selection parts 12 and 22 from the logic circuit 9. The timing generator 5 stops supply of a switching instruction to the read switching parts 11 and 21, and stops output of a switching pulse signal 32 to the logic circuit 9.

The read switching parts 11 disconnect the ADCs 14 from the vertical signal lines 10 that output pixel signals from the Gb pixels and the R pixels, and connect the ADCs 14 to the vertical signal lines 10 that output pixel signals from the B pixels and the Gr pixels. The read switching parts 21 connect the ADCs 24 to the vertical signal lines 10 that output pixel signals from the Gb pixels and the R pixels, and disconnect the ADCs 24 from the vertical signal lines 10 that output pixel signals from the B pixels and the Gr pixels.

In the first one H shown in FIG. 7, the vertical shift register 6 selects a row of R pixels and Gr pixels. At this time, the pixel signals from the Gr pixels are input into the ADCs 14 through the SW1 and SW4 of the circuit selection parts 12. Further, the pixel signals from the R pixels are input into the ADCs 24 through the SW1 and SW4 of the circuit selection parts 22.

In the next one H, the vertical shift register 6 selects a row of Gb pixels and B pixels. At this time, the pixel signals from the B pixels are input into the ADCs 14 through the SW1 and SW4 of the circuit selection parts 12. Further, the pixel signals from the Gb pixels are input into the ADCs 24 through the SW1 and SW4 of the circuit selection parts 22.

The solid-state imaging device 1 repeats the operation described above in the first operation example. In the first operation example, the solid-state imaging device 1 does not perform the weighting addition, and it uses the ADCs 14 to perform AD conversion to the pixel signals from the Gr pixels, and uses the ADCs 24 to perform AD conversion to the pixel signals from the Gb pixels.

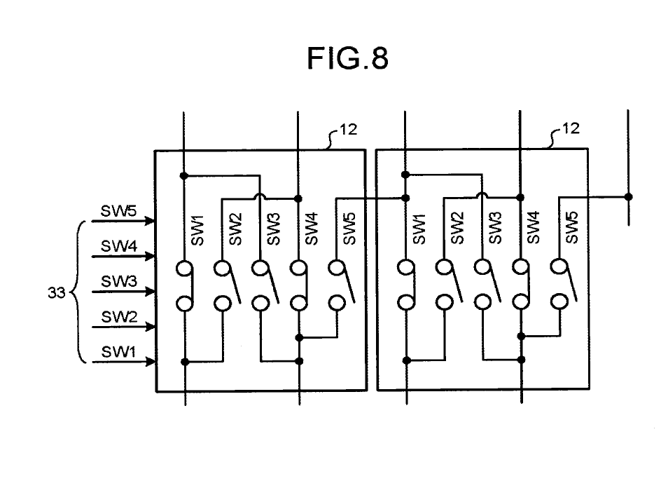

FIG. 8 is a view showing an internal configuration of the selection switches shown in FIG. 7. Each of the circuit selection parts 12 includes two input terminals and two output terminals. Here, each of the circuit selection parts 22 shown in FIG. 7 has the same configuration as that of each circuit selection part 12 shown in FIG. 8.

The input sides of the SW1 and SW2 are connected together to one of the input terminals of each circuit selection part 12. The input sides of the SW3, SW4, and SW5 are connected together to the other of the input terminals of each circuit selection part 12. The SW1 and SW3 are connected together to one of the output terminals of each circuit selection part 12. The SW2 and SW4 are connected together to the other of the output terminals of each circuit selection part 12. The SW5 is connected to one of the output terminals of another circuit selection part 12 adjacent to each circuit selection part 12 including this SW5.

Each circuit selection part 12 switches the ON/OFF of the SW1 to SW5, in response to a switching control signal 33 from the logic circuit 9. The logic circuit 9 holds switching control information corresponding to the contents of each mode setting signal 31, in a register. The switching control information is information that indicates the ON/OFF of the SW1 to SW5.

The switching control information is set in correlation with the presence/absence of switching of the read directions of the vertical signal lines 10 and the contents of processes in the weighting addition circuits 13 and 23. The logic circuit 9 generates a switching control signal 33, in accordance with the presence/absence of the read direction switching and the process contents of the weighting addition.

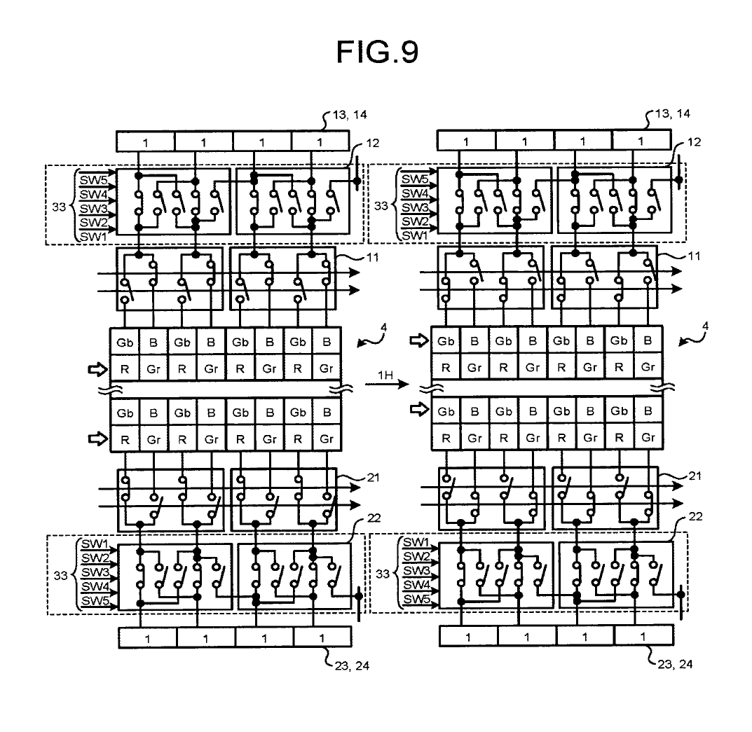

FIG. 9 is a view showing a second operation example of the solid-state imaging device shown in FIG. 1. The second operation example is an operation of the solid-state imaging device 1 performed without the weighting addition and with the read direction switching. A mode setting signal 31 for an operation performed without the weighting addition and with the read direction switching is input into the solid-state imaging device 1. The logic circuit 9 reads switching control information corresponding to the contents of this mode setting signal 31 from a register.

The switching control information read in the second operation example has such contents that use each of the circuit selection parts 12 and the circuit selection parts 22 to set the SW1 to SW5 respectively in ON, OFF, OFF, ON, and OFF, regardless of the horizontal read period. The logic circuit 9 outputs a switching control signal 33 containing the switching control information thus read. The switching control signal 33 is input into each of the circuit selection parts 12 and 22 from the logic circuit 9.

The timing generator 5 supplies a switching instruction to the read switching parts 11 and 21 at every one H. Further, the timing generator 5 stops output of a switching pulse signal 32 to the logic circuit 9.

In the first one H shown in FIG. 9, the vertical shift register 6 selects a row of R pixels and Gr pixels. In this one H, for example, the read switching parts 11 disconnect the ADCs 14 from the vertical signal lines 10 that output pixel signals from the Gb pixels and the R pixels, and connect the ADCs 14 to the vertical signal lines 10 that output pixel signals from the B pixels and the Gr pixels. At this time, the pixel signals from the Gr pixels are input into the ADCs 14 through the SW1 and SW4 of the circuit selection parts 12.

Further, the read switching parts 21 connect the ADCs 24 to the vertical signal lines 10 that output pixel signals from the Gb pixels and the R pixels, and disconnect the ADCs 24 from the vertical signal lines 10 that output pixel signals from the B pixels and the Gr pixels. Thus, the pixel signals from the R pixels are input into the ADCs 24 through the SW1 and SW4 of the circuit selection parts 22.

In the next one H, the vertical shift register 6 selects a row of Gb pixels and B pixels. Each of the read switching parts 11 and 21 switches connection and disconnection, in response to a switching instruction from the timing generator 5. In this one H, the read switching parts 11 connect the ADCs 14 to the vertical signal lines 10 that output pixel signals from the Gb pixels and the R pixels, and disconnect the ADCs 14 from the vertical signal lines 10 that output pixel signals from the B pixels and the Gr pixels. Thus, the pixel signals from the Gb pixels are input into the ADCs 14 through the SW1 and SW4 of the circuit selection parts 12.

Further, the read switching parts 21 disconnect the ADCs 24 from the vertical signal lines 10 that output pixel signals from the Gb pixels and the R pixels, and connect the ADCs 24 to the vertical signal lines 10 that output pixel signals from the B pixels and the Gr pixels. Thus, the pixel signals from the B pixels are input into the ADCs 24 through the SW1 and SW4 of the circuit selection parts 22.

The solid-state imaging device 1 repeats the operation described above in the second operation example. In the second operation example, the solid-state imaging device 1 does not perform the weighting addition, and it uses the ADCs 14 to perform AD conversion to all of the pixel signals from the Gr pixels and the pixel signals from the Gb pixels.

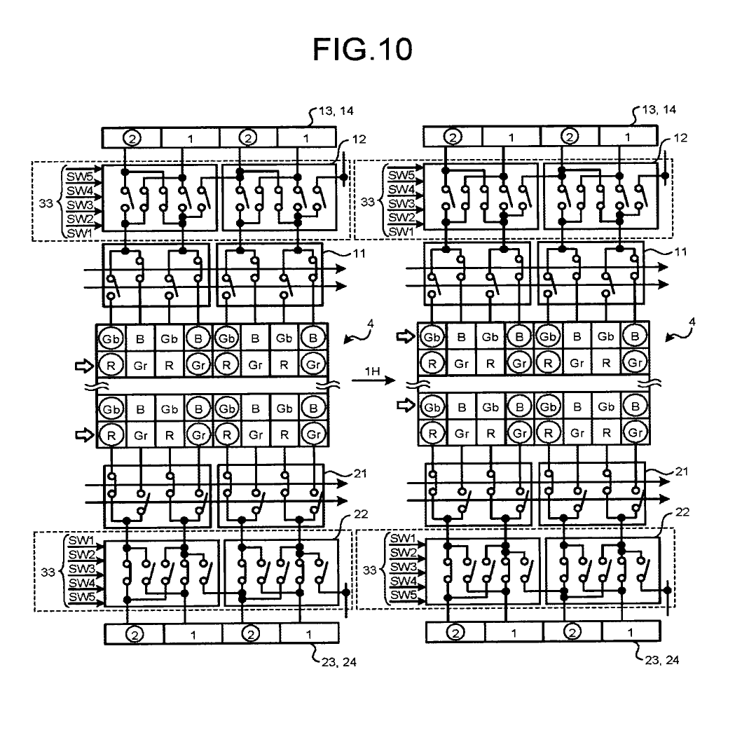

FIG. 10 is a view showing a third operation example of the solid-state imaging device shown in FIG. 1. The third operation example is an operation of the solid-state imaging device 1 performed with the 2-pixel weighting addition and without the read direction switching. A mode setting signal 31 for an operation performed with the 2-pixel weighting addition and without the read direction switching is input into the solid-state imaging device 1. The logic circuit 9 reads switching control information corresponding to the contents of this mode setting signal 31 from a register.

The switching control information read in the third operation example has such contents that use each of the circuit selection parts 12 to set the SW1 to SW5 respectively in OFF, ON, ON, OFF, and OFF, regardless of the horizontal read period. Further, the contents use each of the circuit selection parts 22 to set the SW1 to SW5 respectively in ON, OFF, OFF, ON, and OFF, regardless of the horizontal read period.

The logic circuit 9 outputs a switching control signal 33 containing the switching control information thus read. The switching control signal 33 is input into each of the circuit selection parts 12 and 22 from the logic circuit 9. The timing generator 5 stops supply of a switching instruction to the read switching parts 11 and 21, and stops output of a switching pulse signal 32 to the logic circuit 9.

The read switching parts 11 disconnect the ADCs 14 from the vertical signal lines 10 that output pixel signals from the Gb pixels and the R pixels, and connect the ADCs 14 to the vertical signal lines 10 that output pixel signals from the B pixels and the Gr pixels. The read switching parts 21 connect the ADCs 24 to the vertical signal lines 10 that output pixel signals from the Gb pixels and the R pixels, and disconnect the ADCs 24 from the vertical signal lines 10 that output pixel signals from the B pixels and the Or pixels.

In the first one H shown in FIG. 10, the vertical shift register 6 selects a row of R pixels and Gr pixels. At this time, the circuit selection parts 12 set a state where the pixel signals from the Gr pixels not to be weighted centers are input into weighting circuits 16 for weighting of “1” through the SW2. Further, the circuit selection parts 12 set a state where the pixel signals from the Gr pixels to be weighted centers are input into weighting circuits 16 for weighting of “2” through the SW3. Thus, synthetic pixel signals each subjected to weighting addition of 2:1 for two Gr pixels are input into the ADCs 14.

Further, the circuit selection parts 22 set a state where the pixel signals from the R pixels to be weighted centers are input into weighting circuits 26 for weighting of “2” through the SW1. Further, the circuit selection parts 22 set a state where the pixel signals from the R pixels not to be weighted centers are input into weighting circuits 26 for weighting of “1” through the SW4. Thus, synthetic pixel signals each subjected to weighting addition of 2:1 for two R pixels are input into the ADCs 24.

In the next one H, the vertical shift register 6 selects a row of Gb pixels and B pixels. At this time, the circuit selection parts 12 set a state where the pixel signals from the B pixels not to be weighted centers are input into weighting circuits 16 for weighting of “1” through the SW2. Further, the circuit selection parts 12 set a state where the pixel signals from the B pixels to be weighted centers are input into weighting circuits 16 for weighting of “2” through the SW3. Thus, synthetic pixel signals each subjected to weighting addition of 2:1 for two B pixels are input into the ADCs 14.

Further, the circuit selection parts 22 set a state where the pixel signals from the Gb pixels to be weighted centers are input into weighting circuits 26 for weighting of “2” through the SW1. Further, the circuit selection parts 22 set a state where the pixel signals from the Gb pixels not to be weighted centers are input into weighting circuits 26 for weighting of “1” through the SW4. Thus, synthetic pixel signals each subjected to weighting addition of 2:1 for two Gb pixels are input into the ADCs 24.

The solid-state imaging device 1 repeats the operation described above in the third operation example. In the third operation example, the solid-state imaging device 1 performs the 2-pixel weighting addition. Further, the solid-state imaging device 1 uses the ADCs 14 to perform AD conversion to the pixel signals from the Gr pixels, and uses the ADCs 24 to perform AD conversion to the pixel signals from the Gb pixels.

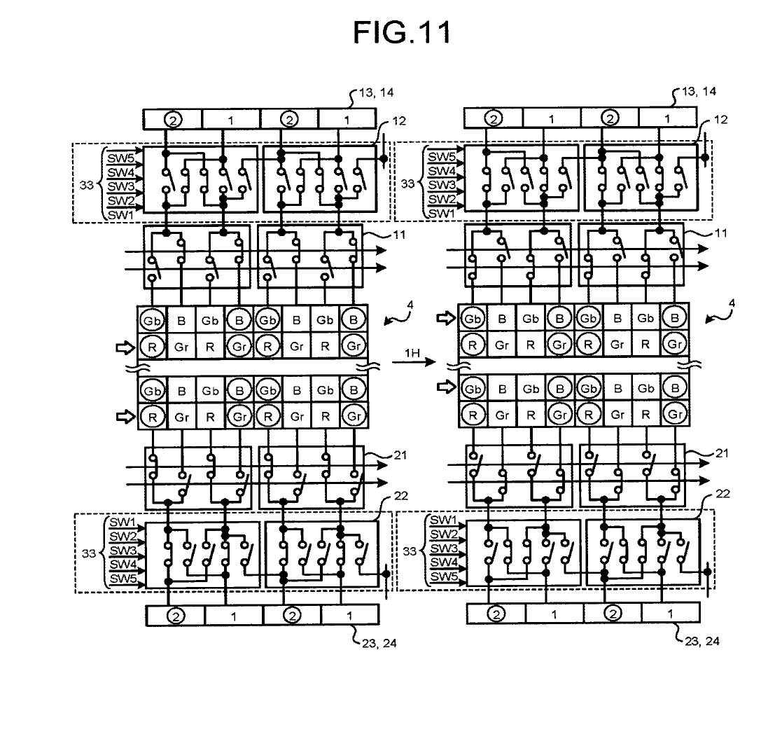

FIG. 11 is a view showing a fourth operation example of the solid-state imaging device shown in FIG. 1. The fourth operation example is an operation of the solid-state imaging device 1 performed with the 2-pixel weighting addition and with the read direction switching. A mode setting signal 31 for an operation performed with the 2-pixel weighting addition and with the read direction switching is input into the solid-state imaging device 1. The logic circuit 9 reads switching control information corresponding to the contents of this mode setting signal 31 from a register.

The switching control information read in the fourth operation example has such contents that use each of the circuit selection parts 12 to set the SW1 to SW5 respectively in OFF, ON, ON, OFF, and OFF, in the horizontal read period that selects a row of R pixels and Gr pixels. The information has such contents that use each of the circuit selection parts 12 to set the SW1 to SW5 respectively in ON, OFF, OFF, ON, and OFF, in the horizontal read period that selects a row of Gb pixels and B pixels.

Further, the switching control information has such contents that use each of the circuit selection parts 22 to set the SW1 to SW5 respectively in ON, OFF, OFF, ON, and OFF, in the horizontal read period that selects a row of R pixels and Gr pixels. The information has such contents that use each of the circuit selection parts 22 to set the SW1 to SW5 respectively in OFF, ON, ON, OFF, and OFF, in the horizontal read period that selects a row of Gb pixels and B pixels.

The logic circuit 9 outputs a switching control signal 33 containing the switching control information thus read. The switching control signal 33 is input into each of the circuit selection parts 12 and 22 from the logic circuit 9. The timing generator 5 supplies a switching instruction to the read switching parts 11 and 21 at every one H. Further, the timing generator 5 outputs a switching pulse signal 32 to the logic circuit 9 at every one H.

In the first one H shown in FIG. 11, the vertical shift register 6 selects a row of R pixels and Gr pixels. In this one H, for example, the read switching parts 11 disconnect the ADCs 14 from the vertical signal lines 10 that output pixel signals from the Gb pixels and the R pixels, and connect the ADCs 14 to the vertical signal lines 10 that output pixel signals from the B pixels and the Gr pixels.

At this time, the circuit selection parts 12 set the SW1 to SW5 respectively in OFF, ON, ON, OFF, and OFF. The circuit selection parts 12 set a state where the pixel signals from the Gr pixels not to be weighted centers are input into weighting circuits 16 for weighting of “1” through the SW2. Further, the circuit selection parts 12 set a state where the pixel signals from the Gr pixels to be weighted centers are input into weighting circuits 16 for weighting of “2” through the SW3. Thus, synthetic pixel signals each subjected to weighting addition of 2:1 for two Gr pixels are input into the ADCs 14.

Further, the read switching parts 21 connect the ADCs 24 to the vertical signal lines 10 that output pixel signals from the Gb pixels and the R pixels, and disconnect the ADCs 24 from the vertical signal lines 10 that output pixel signals from the B pixels and the Gr pixels.

At this time, the circuit selection parts 22 set the SW1 to SW5 respectively in ON, OFF, OFF, ON, and OFF. The circuit selection parts 22 set a state where the pixel signals from the R pixels to be weighted centers are input into weighting circuits 26 for weighting of “2” through the SW1. Further, the circuit selection parts 22 set a state where the pixel signals from the R pixels not to be weighted centers are input into weighting circuits 26 for weighting of “1” through the SW4. Thus, synthetic pixel signals each subjected to weighting addition of 2:1 for two R pixels are input into the ADCs 24.

In the next one H, the vertical shift register 6 selects a row of Gb pixels and B pixels. Each of the read switching parts 11 and 21 switches connection and disconnection, in response to a switching instruction from the timing generator 5.

In this one H, the read switching parts 11 connect the ADCs 14 to the vertical signal lines 10 that output pixel signals from the Gb pixels and the R pixels, and disconnect the ADCs 14 from the vertical signal lines 10 that output pixel signals from the B pixels and the Or pixels. Further, the read switching parts 21 disconnect the ADCs 24 from the vertical signal lines 10 that output pixel signals from the Gb pixels and the R pixels, and connect the ADCs 24 to the vertical signal lines 10 that output pixel signals from the B pixels and the Gr pixels.

The logic circuit 9 generates a switching control signal 33 for switching the ON/OFF of the SW1 to SW5, in response to a switching pulse signal 32 from the timing generator 5, and outputs it to each of the circuit selection parts 12 and 22. Each of the circuit selection parts 12 and 22 switches the ON/OFF of the SW1 to SW5, in response to the switching control signal 33 from the logic circuit 9.

The circuit selection parts 12 switch the SW1 to SW5 respectively to ON, OFF, OFF, ON, and OFF, in response to the switching control signal 33. The circuit selection parts 12 set a state where the pixel signals from the Gb pixels to be weighted centers are input into weighting circuits 16 for weighting of “2” through the SW1. Further, the circuit selection parts 12 set a state where the pixel signals from the Gb pixels not to be weighted centers are input into weighting circuits 16 for weighting of “1” through the SW4. Thus, synthetic pixel signals each subjected to weighting addition of 2:1 for two Gb pixels are input into the ADCs 14.

The circuit selection parts 22 switch the SW1 to SW5 respectively to OFF, ON, ON, OFF, and OFF, in response to the switching control signal 33. The circuit selection parts 22 set a state where the pixel signals from the B pixels not to be weighted centers are input into weighting circuits 26 for weighting of “1” through the SW2. Further, the circuit selection parts 22 set a state where the pixel signals from the B pixels to be weighted centers are input into weighting circuits 26 for weighting of “2” through the SW3. Thus, synthetic pixel signals each subjected to weighting addition of 2:1 for two B pixels are input into the ADCs 24.

The solid-state imaging device 1 repeats the operation described above in the fourth operation example. In the fourth operation example, the solid-state imaging device 1 performs the 2-pixel weighting addition. Further, the solid-state imaging device 1 uses the ADCs 14 to perform AD conversion to all of the pixel signals from the Gr pixels and the pixel signals from the Gb pixels.

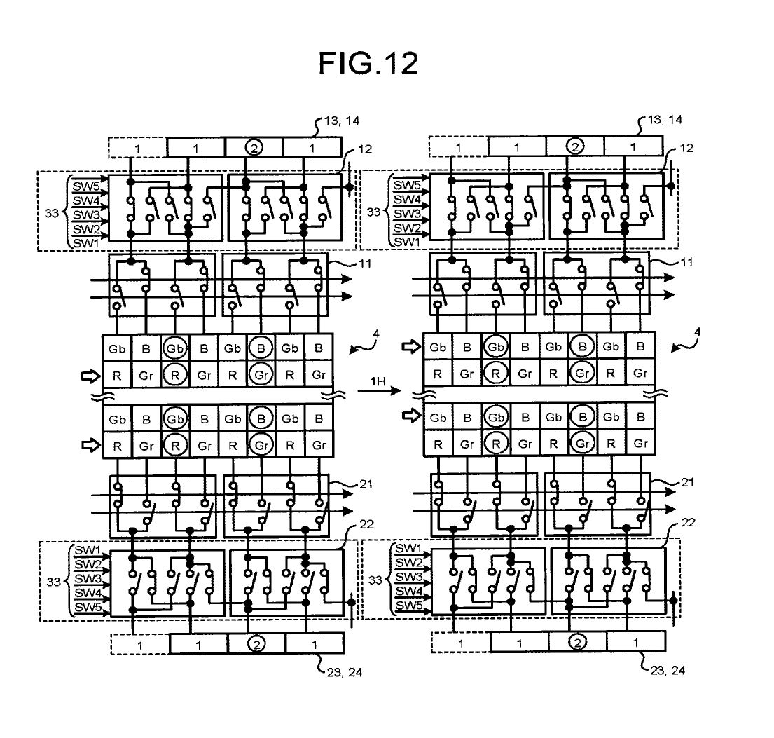

FIG. 12 is a view showing a fifth operation example of the solid-state imaging device shown in FIG. 1. The fifth operation example is an operation of the solid-state imaging device 1 performed with the 3-pixel weighting addition and without the read direction switching. A mode setting signal 31 for an operation performed with the 3-pixel weighting addition and without the read direction switching is input into the solid-state imaging device 1. The logic circuit 9 reads switching control information corresponding to the contents of this mode setting signal 31 from a register.

The switching control information read in the fifth operation example has such contents that use each of the circuit selection parts 12 to set the SW1 to SW5 respectively in ON, OFF, OFF, ON, and OFF, regardless of the horizontal read period. Further, the contents use each of the circuit selection parts 22 to set the SW1 to SW5 respectively in OFF, ON, OFF, OFF, and ON, regardless of the horizontal read period.

The logic circuit 9 outputs a switching control signal 33 containing the switching control information thus read. The switching control signal 33 is input into each of the circuit selection parts 12 and 22 from the logic circuit 9. The timing generator 5 stops supply of a switching instruction to the read switching parts 11 and 21, and stops output of a switching pulse signal 32 to the logic circuit 9.

The read switching parts 11 disconnect the ADCs 14 from the vertical signal lines 10 that output pixel signals from the Gb pixels and the R pixels, and connect the ADCs 14 to the vertical signal lines 10 that output pixel signals from the B pixels and the Gr pixels. The read switching parts 21 connect the ADCs 24 to the vertical signal lines 10 that output pixel signals from the Gb pixels and the R pixels, and disconnect the ADCs 24 from the vertical signal lines 10 that output pixel signals from the B pixels and the Gr pixels.

In the first one H shown in FIG. 12, the vertical shift register 6 selects a row of R pixels and Gr pixels. At this time, the circuit selection parts 12 set a state where the pixel signals from the Gr pixels not to be weighted centers are input into weighting circuits 16 for weighting of “1” through the SW4. Further, the circuit selection parts 12 set a state where the pixel signals from the Gr pixels to be weighted centers are input into weighting circuits 16 for weighting of “2” through the SW1. Thus, synthetic pixel signals each subjected to weighting addition of 1:2:1 for three Gr pixels are input into the ADCs 14.

Further, the circuit selection parts 22 set a state where the pixel signals from the R pixels not to be weighted centers are input into weighting circuits 26 for weighting of “1” through the SW2. Further, the circuit selection parts 22 set a state where the pixel signals from the R pixels to be weighted centers are input into weighting circuits 26 for weighting of “2” through the SW5. Thus, synthetic pixel signals each subjected to weighting addition of 1:2:1 for three R pixels are input into the ADCs 24.

In the next one H, the vertical shift register 6 selects a row of Gb pixels and B pixels. At this time, the circuit selection parts 12 set a state where the pixel signals from the B pixels not to be weighted centers are input into weighting circuits 16 for weighting of “1” through the SW4. Further, the circuit selection parts 12 set a state where the pixel signals from the B pixels to be weighted centers are input into weighting circuits 16 for weighting of “2” through the SW1. Thus, synthetic pixel signals each subjected to weighting addition of 1:2:1 for three B pixels are input into the ADCs 14.

Further, the circuit selection parts 22 set a state where the pixel signals from the Gb pixels not to be weighted centers are input into weighting circuits 26 for weighting of “1” through the SW2. Further, the circuit selection parts 22 set a state where the pixel signals from the Gb pixels to be weighted centers are input into weighting circuits 26 for weighting of “2” through the SW5. Thus, synthetic pixel signals each subjected to weighting addition of 1:2:1 for three Gb pixels are input into the ADCs 24.

The solid-state imaging device 1 repeats the operation described above in the fifth operation example. In the fifth operation example, the solid-state imaging device 1 performs the 3-pixel weighting addition. Further, the solid-state imaging device 1 uses the ADCs 14 to perform AD conversion to the pixel signals from the Gr pixels, and uses the ADCs 24 to perform AD conversion to the pixel signals from the Gb pixels.

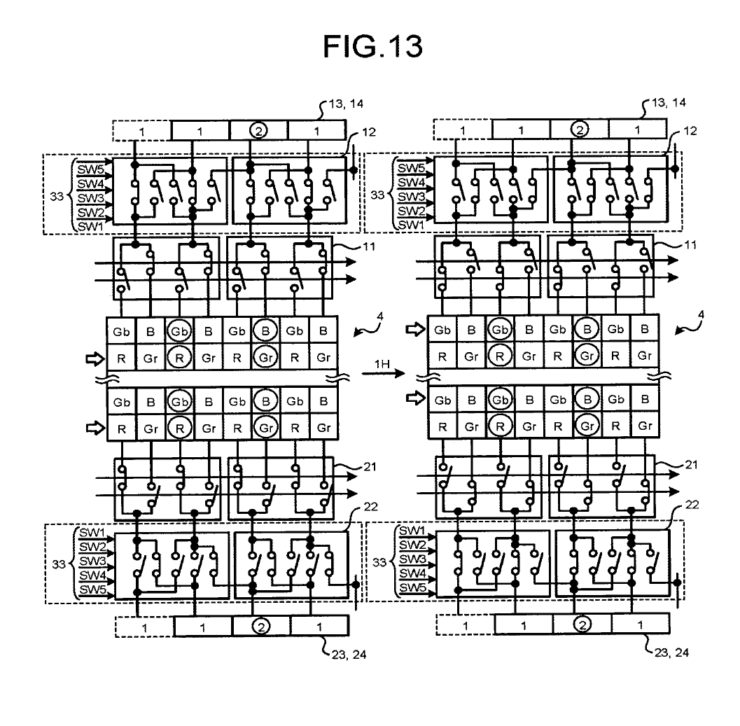

FIG. 13 is a view showing a sixth operation example of the solid-state imaging device shown in FIG. 1. The sixth operation example is an operation of the solid-state imaging device 1 performed with the 3-pixel weighting addition and with the read direction switching. A mode setting signal 31 for an operation performed with the 3-pixel weighting addition and with the read direction switching is input into the solid-state imaging device 1. The logic circuit 9 reads switching control information corresponding to the contents of this mode setting signal 31 from a register.

The switching control information read in the sixth operation example has such contents that use each of the circuit selection parts 12 to set the SW1 to SW5 respectively in ON, OFF, OFF, ON, and OFF, in the horizontal read period that selects a row of R pixels and Gr pixels. The information has such contents that use each of the circuit selection parts 12 to set the SW1 to SW5 respectively in OFF, ON, OFF, OFF, and ON, in the horizontal read period that selects a row of Gb pixels and B pixels.

Further, the switching control information has such contents that use each of the circuit selection parts 22 to set the SW1 to SW5 respectively in OFF, ON, OFF, OFF, and ON, in the horizontal read period that selects a row of R pixels and Gr pixels. The information has such contents that use each of the circuit selection parts 22 to set the SW1 to SW5 respectively in ON, OFF, OFF, ON, and OFF, in the horizontal read period that selects a row of Gb pixels and B pixels.

The logic circuit 9 outputs a switching control signal 33 containing the switching control information thus read. The switching control signal 33 is input into each of the circuit selection parts 12 and 22 from the logic circuit 9. The timing generator 5 supplies a switching instruction to the read switching parts 11 and 21 at every one H. Further, the timing generator 5 outputs a switching pulse signal 32 to the logic circuit 9 at every one H.

In the first one H shown in FIG. 13, the vertical shift register 6 selects a row of R pixels and Gr pixels. In this one H, for example, the read switching parts 11 disconnect the ADCs 14 from the vertical signal lines 10 that output pixel signals from the Gb pixels and the R pixels, and connect the ADCs 14 to the vertical signal lines 10 that output pixel signals from the B pixels and the Gr pixels.

At this time, the circuit selection parts 12 set the SW1 to SW5 respectively in ON, OFF, OFF, ON, and OFF. The circuit selection parts 12 set a state where the pixel signals from the Gr pixels not to be weighted centers are input into weighting circuits 16 for weighting of “1” through the SW4. Further, the circuit selection parts 12 set a state where the pixel signals from the Gr pixels to be weighted centers are input into weighting circuits 16 for weighting of “2” through the SW1. Thus, synthetic pixel signals each subjected to weighting addition of 1:2:1 for three Gr pixels are input into the ADCs 14.

Further, the read switching parts 21 connect the ADCs 24 to the vertical signal lines 10 that output pixel signals from the Gb pixels and the R pixels, and disconnect the ADCs 24 from the vertical signal lines 10 that output pixel signals from the B pixels and the Gr pixels.

At this time, the circuit selection parts 22 set the SW1 to SW5 respectively in OFF, ON, OFF, OFF, and ON. The circuit selection parts 22 set a state where the pixel signals from the R pixels not to be weighted centers are input into weighting circuits 26 for weighting of “1” through the SW2. Further, the circuit selection parts 22 set a state where the pixel signals from the R pixels to be weighted centers are input into weighting circuits 26 for weighting of “2” through the SW5. Thus, synthetic pixel signals each subjected to weighting addition of 1:2:1 for three R pixels are input into the ADCs 24.

In the next one H, the vertical shift register 6 selects a row of Gb pixels and B pixels. Each of the read switching parts 11 and 21 switches connection and disconnection, in response to a switching instruction from the timing generator 5.

In this one H, the read switching parts 11 connect the ADCs 14 to the vertical signal lines 10 that output pixel signals from the. Gb pixels and the R pixels, and disconnect the ADCs 14 from the vertical signal lines 10 that output pixel signals from the B pixels and the Gr pixels. Further, the read switching parts 21 disconnect the ADCs 24 from the vertical signal lines 10 that output pixel signals from the Gb pixels and the R pixels, and connect the ADCs 24 to the vertical signal lines 10 that output pixel signals from the B pixels and the Gr pixels.

The logic circuit 9 generates a switching control signal 33 for switching the ON/OFF of the SW1 to SW5, in response to a switching pulse signal 32 from the timing generator 5, and outputs it to each of the circuit selection parts 12 and 22. Each of the circuit selection parts 12 and 22 switches the ON/OFF of the SW1 to SW5, in response to the switching control signal 33 from the logic circuit 9.

The circuit selection parts 12 switch the SW1 to SW5 respectively to OFF, ON, OFF, OFF, and ON, in response to the switching control signal 33. The circuit selection parts 12 set a state where the pixel signals from the Gb pixels not to be weighted centers are input into weighting circuits 16 for weighting of “1” through the SW2. Further, the circuit selection parts 12 set a state where the pixel signals from the Gb pixels to be weighted centers are input into weighting circuits 16 for weighting of “2” through the SW5. Thus, synthetic pixel signals each subjected to weighting addition of 1:2:1 for three Gb pixels are input into the ADCs 14.

The circuit selection parts 22 switch the SW1 to SW5 respectively to ON, OFF, OFF, ON, and OFF, in response to the switching control signal 33. The circuit selection parts 22 set a state where the pixel signals from the B pixels not to be weighted centers are input into weighting circuits 26 for weighting of “1” through the SW4. Further, the circuit selection parts 22 set a state where the pixel signals from the B pixels to be weighted centers are input into weighting circuits 26 for weighting of “2” through the SW1. Thus, synthetic pixel signals each subjected to weighting addition of 1:2:1 for three B pixels are input into the ADCs 24.

The solid-state imaging device 1 repeats the operation described above in the sixth operation example. In the sixth operation example, the solid-state imaging device 1 performs the 3-pixel weighting addition. Further, the solid-state imaging device 1 uses the ADCs 14 to perform AD conversion to all of the pixel signals from the Gr pixels and the pixel signals from the Gb pixels.

According to an embodiment, the solid-state imaging device 1 allows the circuit selection parts 12 and 22 to switch pixel signals to be input into the weighting circuits 16 and 26, in response to switching of the read directions of the vertical signal lines 10. The solid-state imaging device 1 can input the pixel signals from the Gr pixels and the pixel signals from the Gb pixels constantly into the ADCs 14 on the same side, and can perform weighting addition at a desired ratio to the pixel signals. Consequently, the solid-state imaging device 1 provides an effect capable of performing read of the pixel signals and performing weighting addition to the pixel signals, while switching the read directions of the vertical signal lines 10. Thus, the solid-state imaging device 1 can realize a desired signal process.

It should be noted that the solid-state imaging device 1 is not limited to one that can perform both of weighting addition of 2:1 and weighting addition of 1:2:1. The solid-state imaging device 1 is supposed to be effective, if it can perform at least one of these types of weighting addition. Further, the solid-state imaging device 1 may be designed to perform weighting addition at any preset ratio other than those explained in the embodiment. The configuration of the circuit selection parts 12 and 22 may be suitably changed in accordance with a manner of performing weighting addition.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A solid-state imaging device comprising:
a pixel array;
a weighting addition circuit including weighting circuits for performing weighting to pixel signals read from the pixel array through vertical signal lines, and configured to add up the pixel signals subjected to the weighting;
selecting circuits configured to select some of the weighting circuits to be used for the weighting, in association with pixel signals read through plural ones of the vertical signal lines;
read switching circuits configured to switch read directions of pixel signals from the vertical signal lines; and
a switching control circuit configured to output a control signal for switching selection of the weighting circuits to the selecting circuits, in response to switching of the read directions.

2. The solid-state imaging device according to claim 1, wherein the read switching circuits are configured to switch the read directions between a first direction and a second direction opposite to the first direction, and
the weighting addition circuit includes
a first weighting addition circuit including first weighting circuits of the weighting circuits, for performing the weighting to pixel signals read in the first direction, and
a second weighting addition circuit including second weighting circuits of the weighting circuits, for performing the weighting to pixel signals read in the second direction.

3. The solid-state imaging device according to claim 2, wherein the selecting circuits include
first selecting circuits configured to select some of the first weighting circuits to be used for the weighting, in association with pixel signals read in the first direction through plural ones of the vertical signal lines, and
second selecting circuits configured to select some of the second weighting circuits to be used for the weighting, in association with pixel signals read in the second direction through plural ones of the vertical signal lines.

4. The solid-state imaging device according to claim 2, comprising:
first AD converters configured to perform AD conversion to synthetic pixel signals subjected to weighting addition in the first weighting addition circuit; and
second AD converters configured to perform AD conversion to synthetic pixel signals subjected to weighting addition in the second weighting addition circuit.

5. The solid-state imaging device according to claim 1, wherein the switching control circuit is configured to generate a control signal for switching control over the selecting circuits, in response to a mode setting signal corresponding to setting of a photographing mode.

6. The solid-state imaging device according to claim 5, wherein the switching control circuit holds control information, the control information being included presence/absence of switching of the read directions and contents of weighting addition of the weighting addition circuit, and
the switching control circuit is configured to generate a control signal for controlling the selecting circuits, in accordance with the control information read in response to the mode setting signal.

7. The solid-state imaging device according to claim 1, comprising:
programmable gain amplifier circuits respectively connected to output sides of the weighting circuits, and configured to respectively multiply synthetic pixel signals, subjected to weighting addition, by a gain; and
AD converters respectively connected to the programmable gain amplifier circuits, and configured to perform AD conversion to the synthetic pixel signals,
wherein those of the programmable gain amplifier circuits and the AD converters, which are on columns that receive no input of the synthetic pixel signals, are disconnected from a power supply.

8. The solid-state imaging device according to claim 1, wherein the weighting addition circuit is configured to switch processes between a process performed without weighting addition, a process performed with 2-pixel weighting addition, and a process performed with 3-pixel weighting addition.

9. An imaging method performed in a solid-state imaging device, the method comprising:
performing weighting to pixel signals read from a pixel array through vertical signal lines;
adding up the pixel signals subjected to the weighting;
selecting some of weighting circuits to be used for the weighting, in association with pixel signals read through plural ones of the vertical signal lines;
switching read directions of pixel signals from the vertical signal lines; and
switching selection of the weighting circuits, in response to switching of the read directions.

10. The imaging method according to claim 9, comprising:
switching the read directions between a first direction and a second direction opposite to the first direction;
performing the weighting to pixel signals read in the first direction; and
performing the weighting to pixel signals read in the second direction.

11. The imaging method according to claim 10, comprising:
selecting some of first weighting circuits of the weighting circuits to be used for the weighting, in association with pixel signals read in the first direction through plural ones of the vertical signal lines; and
selecting some of second weighting circuits of the weighting circuits to be used for the weighting, in association with pixel signals read in the second direction through plural ones of the vertical signal lines.

12. The imaging method according to claim 11, comprising:
causing first AD converters to perform AD conversion to synthetic pixel signals subjected to weighting addition in the first weighting circuits; and
causing second AD converters to perform AD conversion to synthetic pixel signals subjected to weighting addition in the second weighting circuits.

13. The imaging method according to claim 9, comprising:
switching control over selection of the weighting circuits, in response to a mode setting signal corresponding to setting of a photographing mode.

14. The imaging method according to claim 13, comprising:
holding control information including presence/absence of switching of the read directions and contents of weighting addition; and
controlling selection of the weighting circuits, in accordance with the control information read in response to the mode setting signal.

15. The imaging method according to claim 9, further comprising:
causing programmable gain amplifier circuits respectively connected to output sides of the weighting circuits to respectively multiply synthetic pixel signals, subjected to weighting addition, by a gain; and
causing AD converters to perform AD conversion to the synthetic pixel signals multiplied by the gain;
wherein the imaging method comprises disconnecting those of the programmable gain amplifier circuits and the AD converters, which are on columns that receive no input of the synthetic pixel signals, from a power supply.

16. The imaging method according to claim 9, wherein the imaging method is capable of switching processes between a process performed without weighting addition, a process performed with 2-pixel weighting addition, and a process performed with 3-pixel weighting addition.
